(19) United States
(12) Patent Application Publication
(10) Pub. No.: US 2006/0083397 A1
(43) Pub. Date: Apr. 20, 2006

(54) Wireless headphone with a self-actuated switch

(75) Inventor: Hsien-Ta Chen, Taoyuan City (TW)

Correspondence Address: NIKOLAI & MERSEREAU, P.A., 900 SECOND AVENUE SOUTH, SUITE 820, MINNEAPOLIS, MN, 55402, US

(73) Assignee: OBO PRO.2 INC., Taoyuan City (TW)

(21) Appl. No.: 10/968,512

(22) Filed: Oct. 19, 2004

(51) Int. Cl. H04R 25/00

(52) U.S. Cl. 381/370; 381/378; 381/384

(57) ABSTRACT

A wireless headphone with a self-actuated switch has a belt, two retainers and a self-actuated switch. The self-actuated switch has a base and a resilient bar. The base is mounted in a mounting recess in the belt and has a button. The resilient bar is mounted in the mounting recess in the belt and selectively presses against the button. Bending the belt will force the resilient bar to move forward to press the button. When the button is pressed, the wireless headphone will be actuated, and reverse.

### BACKGROUND OF THE INVENTION

1. Field of the Invention

The present invention relates to a wireless headphone, especially to a wireless headphone with a self-actuated switch.

2. Description of the Prior Arts

A headphone is used on personal music devices such as a Walkman®, a CD-player, hi-fi equipment, etc. to transmit sound and in particular music, in a vividly stereophonic manner, whereby the user can enjoy loud music without disturbing others. A conventional headphone is connected to the appropriate device by an electric wire. However, the electric wire can be a nuisance in terms of restricting the user's movements while the headphone is connected to a large hi-fi device and so wireless headphones have become a popular alternative. Because the wireless headphone has no wire to connect to the broadcast equipment, the electric power is provided by batteries that are mounted in the wireless headphone. If the headphone is unintentionally left in a power on status but no music is being played, the user will be unaware of the power waste situation. This can ultimately be irritating because when someone wants to relax by listening to music with such headphones, it is a nuisance to then have to go out and buy replacement batteries. In order to avoid the waste of the batteries, the wireless headphone has a switch to control the electric connection. Nevertheless, it is found that on one hand the conventional switch has to be located in an easily accessible position but on the other hand such a location means the switch is easily actuated unintentionally, such as by putting down the headphones. To overcome the shortcoming, the present invention provides a wireless headphone with a self-actuated switch to mitigate or obviate the aforementioned problems.

### SUMMARY OF THE INVENTION

The main objective of the present invention is to provide a wireless headphone with a self-actuated switch.

The wireless headphone with the self-actuated switch comprises a belt, two retainers and a self-actuated switch. The self-actuated switch has a base and a resilient bar. The base is mounted in a mounting recess in the belt and has a button. The resilient bar is mounted in the mounting recess in the belt and selectively presses against the button. Bending the belt will force the resilient bar to move forward. When the button is pressed, the wireless headphone will be actuated.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wireless headphone with a self-actuated switch in accordance with the present invention;

FIG. 2 is a top view of the wireless headphone with the self-actuated switch in FIG. 1;

FIG. 3 is a front view in partial section of the wireless headphone with the self-actuated switch in FIG. 1 when the switch is not actuated; and

FIG. 4 is a front view in partial section of the wireless headphone with the self-actuated switch in FIG. 1 when the switch is self-actuated.

### DETAILED DESCRIPTION OF THE PREFERRED EMBODIMENTS

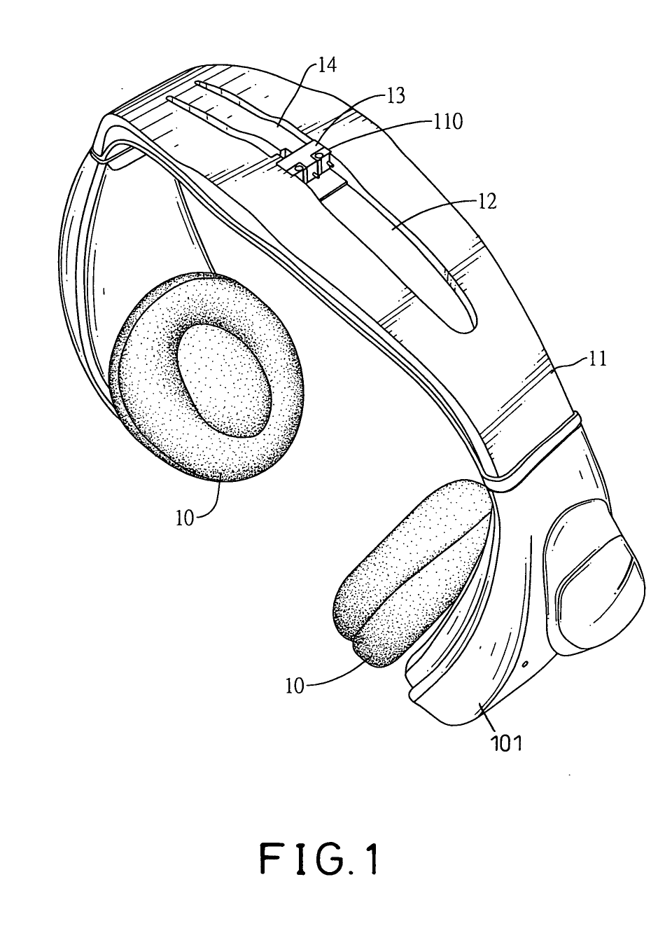

With reference to FIG. 1, a wireless headphone with a self-actuated switch in accordance with the present invention comprises a belt (11), two retainers (101) and a self-actuated switch. The belt (11) has two ends, a middle part, a mounting recess (12) and an optional holding block (110). The mounting recess (12) is formed in the belt (11) and is optionally formed in the middle part of the belt (11). The holding block (110) is formed in the mounting recess (12). The retainers (101) are mounted respectively on the two ends of the belt (11) and each retainer (101) has a housing (10) mounted on the retainer (101).

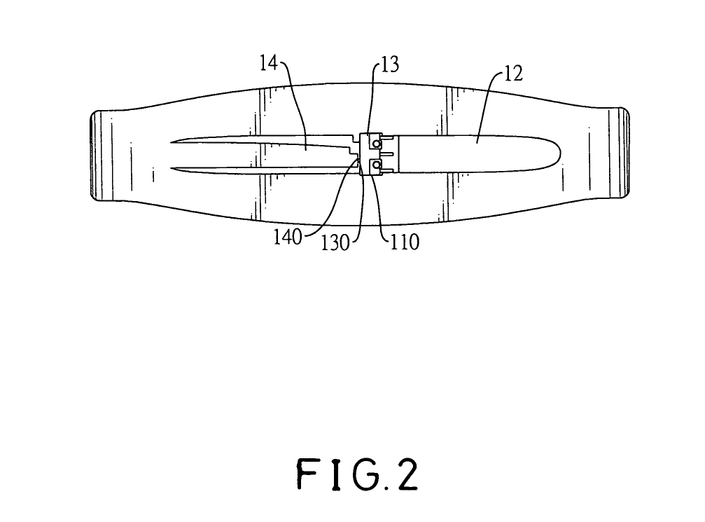

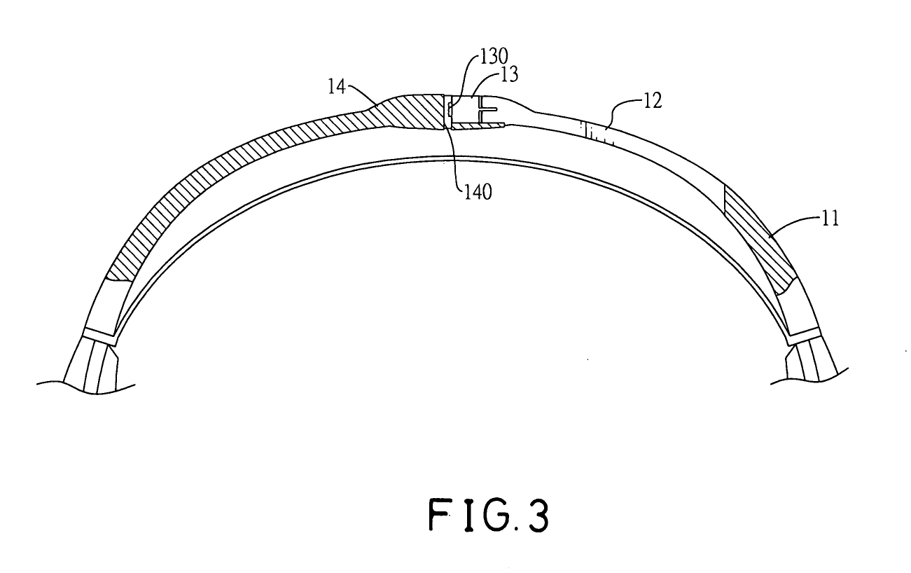

With further reference to FIGS. 2 and 3, the self-actuated switch is mounted in the belt (11) and comprises a base (13) and a resilient bar (14).

The base (13) is mounted in the mounting recess (12) and on the holding block (110) and has a proximal end, a distal end and a button (130). The proximal end connects to the holding block (110). The button (130) is formed on the distal end of the base (13). When the button is pressed, the wireless headphone will be actuated, as to be described in detail later.

The resilient bar (14) is mounted in the mounting recess (12), extends into the mounting recess (12), is optionally formed on the belt (11) and has a proximal end, a distal end and an optional contacting surface (140). The contacting surface (140) is formed on the distal end and selectively presses against the button (130) on the base (13).

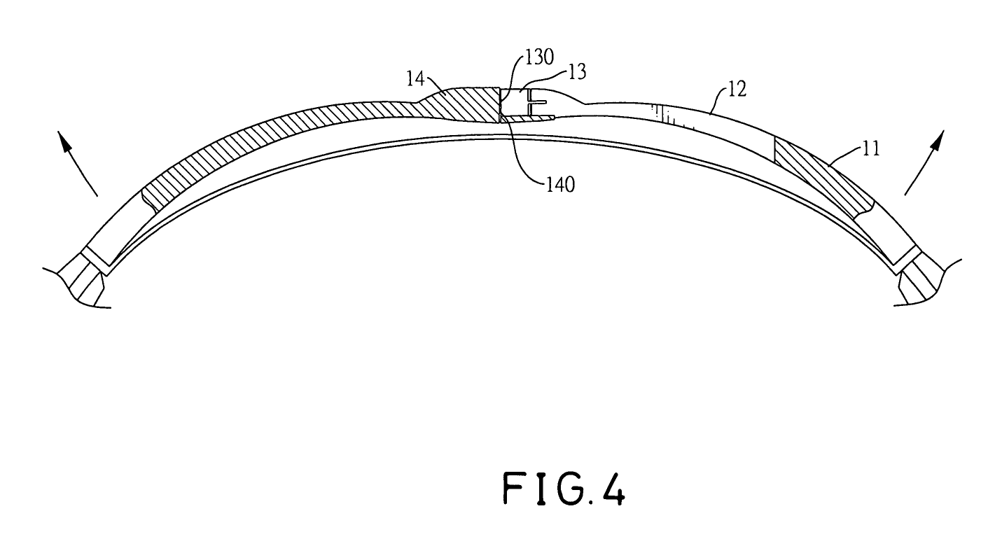

With further reference to FIG. 4, a user has to flex the belt (11) of the wireless headphone to put the housing (10) around ears of the user. The contacting surface (140) on the distal end of the resilient bar (14) will move forward when the belt (11) is flexed outwardly. Then the contacting surface (140) will press the button (130) on the base (13) and actuates the wireless headphone.

The self-actuated switch on a wireless headphone as described makes a huge improvement. Whenever the user wears the wireless headphone, the switch will be self-actuated by the flexing of the belt (11). Because the switch is actuated only when the belt (11) is flexed, the switch will not be unintentionally actuated. Furthermore, when the headphone is removed and no longer required, the power consumption is automatically terminated. Hence, both situations automatically prevent prematurely exhausting the batteries.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wireless headphone with a self-actuated switch comprising
a belt having
two ends;
a middle part; and
a mounting recess formed in the belt;
two retainers mounted respectively on the two ends of the belt and each retainer having a housing mounted on the retainer;
a base mounted in the mounting recess and having
a proximal end;
a distal end; and
a button formed on the distal end wherein the wireless headphone will be actuated when the button is pressed;
a resilient bar mounted in the mounting recess, extending into the mounting recess and having
a proximal end; and
a distal end selectively contacting with the button.

2. The wireless headphone as claimed in claim 1, wherein the mounting recess is formed in the middle part of the belt.

3. The wireless headphone as claimed in claim 1, wherein
the belt further comprises a holding block formed in the mounting recess; and
the base is further mounted on the holding block.

4. The wireless headphone as claimed in claim 1, wherein the resilient bar further comprises a contacting surface formed on the distal end and selectively pressing against the button on the base.

5. The wireless headphone as claimed in claim 1, wherein the resilient bar is formed on the belt.
